(19) United States
(12) Patent Application Publication
(10) Pub. No.: US 2010/0206095 A1
(43) Pub. Date: Aug. 19, 2010

(54) REGENERATION OF A FLUID FILTER CONTROLLED BY A PRESSURE DROP MONITOR

(76) Inventor: Zeev Yehieli, Kibbutz Eyal (IL)

Correspondence Address: The Law Office of Michael E. Kondoudis, 888 16th Street, N.W., Suite 800, Washington, DC, 20006, US

(21) Appl. No.: 12/667,402

(22) PCT Filed: Jul. 6, 2008
(86) PCT No.: PCT/IL08/00923

§ 371 Date: Dec. 31, 2009

(30) Foreign Application Priority Data
Jul. 4, 2007 (IL) 184410

(51) Int. Cl. G01N 1/10

(52) U.S. Cl. 73/863.23

(57) ABSTRACT

A system for monitoring fluid quality within a fluid flow in real time, is disclosed. The system comprises (a) a fluid filter incorporated into the fluid flow; the filter is adapted for filtering the fluid flow; (b) sensor means adapted for measuring a difference between an upstream pressure and a downstream pressure of the fluid flow; and (c) control means. The control means is adapted for estimating the fluid quality on a base of measuring a time period of rise in the pressure difference at the filter over a predetermined value.

### CROSS-REFERENCE TO RELATED APPLICATIONS

This application is a National Stage of International Application No. PCT/IL2008/000923, filed Jul. 6, 2008, which claims the benefit of priority from Israeli Patent Application No. 184410, filed Jul. 4, 2007.

### FIELD OF THE INVENTION

The present invention relates to an automatic clogging rate monitor.

### BACKGROUND OF THE INVENTION

The invention relates to realtime monitoring of water quality, in particular monitoring the rate of clogging. The invention further provides a system for automatic replacement of filters that are judged to be at the end of their lifetime.

Clogging is problematic in many irrigation systems, particularly in continuous-flow systems such as used in drip irrigation. Uneven or blocked irrigation can cause deterioration or loss of crops, for example. Clogging of filters, nozzles, drip heads, and pipes or hoses can all contribute to this problem, which in general is a result of interactions between the water quality and environmental conditions. Often it is difficult to predict clogging on the basis of the standard parameters of water quality such as temperature, pH, hardness, turbidity, total suspended solids, total dissolved solids, etc. As the use of continuous irrigation systems increases, it is expected that the problems of clogging in these systems will also increase. It can be appreciated that a system that would predict clogging, and that would furthermore operate continuously in realtime and send results through a wireless network such as a cellular phone network would realize significant advantages over traditional systems wherein the clogging rate is tested by hand or not at all. A system that can automatically replace clogged filters will find even greater demand.

Turbidity refers to a liquid's cloudiness or haziness. If turbidity of a water sample is measured, it provides an indication of the total suspended solids (such as phytoplankton) in the sample. It can be measured by various methods such as measuring the absorbed or scattered light. The nephelometric turbidity sensor for example is a commonly used method of determining turbidity in water, consisting of an apparatus that measures the scattering of light perpendicular to the direction of light propagation. As the water's turbidity increases, the amount of light scattered to the side will also increase. The InPro 8600 Wireless turbidity sensor incorporates wireless communication with an inline transmitted- and scattered-light turbidity sensor. However it can be appreciated that simple measurement of turbidity does not directly correlate to the speed or likelihood of clogging of various system elements. For example, the introduction of black ink into the flow would greatly increase the measured turbidity, yet if the ink were entirely dissolved, this would have no bearing on the rate of system clogging.

Korean patent application KR20020010883 provides an alarm apparatus for detecting the quality of water stored in a water tank of a building automatically. The system will inform the user concerning the deterioration of water quality by using a wireless communication network. The alarm apparatus for detecting the quality of water stored in a water tank of a building comprises a water quality detection part composed of a dissolved oxygen sensor, a turbidity sensor, and an acidity sensor; a signal amplification part; a central control part for outputting a call number saved in a memory, and a wireless sending part for automatically sending information concerning a water pollution situation to a wireless communication network.

While providing a water-quality monitoring system that outputs information in realtime to a cellular network, it is clear that the information concerns only those parameters measured, namely dissolved oxygen, turbidity, and acidity. The clogging rate, which is not directly measured by any of these methods, remains unknown. Furthermore no provision is made for automatically replacement of clogged filters is not disclosed.

Hence, a system for measuring clogging rate automatically and transmitting this information to a wireless network is still a long felt need. Such a system, which in addition would in real time distinguish and report sand-like fouling, algal fouling and fouling due to zooplankton would further fulfill a long felt need. Such a system that furthermore provides means for replacement of clogged filters when necessary would obviously fulfill an additional need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 schematically presents a system diagram for the measurement of clogging rate and transmission of this measurement to a wireless network.

FIG. 2 presents a photograph of a water sample.

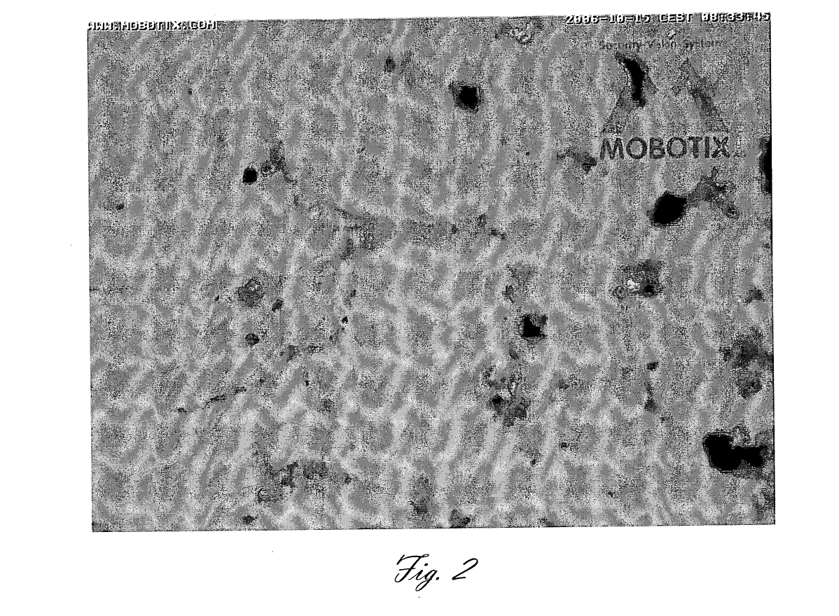

FIG. 3 presents a photograph of a water sample.

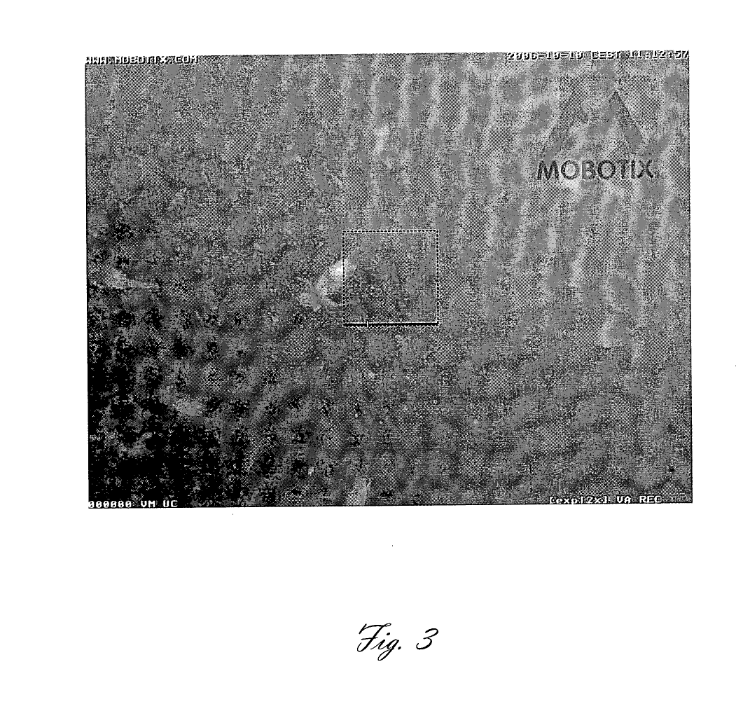

FIG. 4 schematically presents an example of the online camera arrangement, with FIG. 4a and FIG. 4b being side views and 4c being an isometric view.

FIG. 5 schematically presents an example of an inline filter roll.

FIG. 6 schematically presents an example of an inline filter magazine.

### SUMMARY OF THE INVENTION

The invention is a system for directly measuring clogging rate in fluid supply systems. It provides a real-time measurement, and delivers information concerning clogging rate to a wireless network (such as a cellular phone network). The measurement of clogging rate is done directly unlike other systems which measure parameters of fluid quality such as turbidity, pH, etc. Embodiments are also provided for cleaning clogged filters by reversing the fluid flow across them. Embodiments are also provided for automatically replacing the filter when it is clogged from a magazine supply of filters. Another embodiment provides a strip of filter material that is pulled across the fluid line to introduce fresh filter material into the line when necessary.

It is an object of the invention to provide a system for monitoring fluid quality within a fluid flow in real time. The aforesaid system comprises (a) a fluid filter lined/incorporated into the fluid flow; the filter is adapted for filtering said fluid flow; (b) sensor means adapted for measuring a difference between an upstream pressure and a downstream pressure of the fluid flow; and (c) control means.

It is a core purpose of the invention to provide the control means is adapted for estimating said fluid quality on a base of measuring a time period of rise in said pressure difference at said filter over a predetermined value.

It is another object of the invention to provide the system further comprises means for reversing the flow across the filter. The means are adapted for backflashing said filter in response to rise in the pressure difference at the filter over a predetermined value.

It is a further object of the invention to provide the system further comprising normally open valves disposed in upstream and downstream positions relative to the filter and replacing means adapted for automatically replacing the filter. The control means is adapted for activating the replacing means in a response to detecting a rise in the pressure difference above a predetermined value such that the filter is replaced when the upstream and downstream valves are closed.

It is a further object of the invention to provide the sensor means which is a differential pressure transducer.

It is a further object of the invention to provide the replacing means further comprising a feeding magazine adapted for feeding fresh filters to be placed as a substitute for a used one.

It is a further object of the invention to provide the filter shaped into a strip wound on a reel. The replacing means is adapted for drawing the strip through the fluid flow.

It is a further object of the invention to provide the replacing means adapted for drawing the filter through a flow area in a continuous and/or discrete manner.

It is a further object of the invention wherein said information transmission means is selected from a group consisting of: cellular radio network, cellular phone network, wireless transmission network, Ethernet connection, Bluetooth connection, serial connection, parallel connection.

It is a further object of the invention to provide means for real-time photography of water samples passing said filter.

It is a further object of the invention wherein said photography is of sufficient resolution and quality so as to enable sand, algae and zooplankton to be distinguished.

It is a further object of the invention wherein said fluid is selected from suspensions of solid matter, especially fine particles, powders, nano- and micrometric-scale aggregates, milled fibers, corpuscles and other blood products, liquids, water immiscible solutions, water miscible solutions, water, water suspensions, emulsions, milk and milk products, blood, body fluids, beverages, brewed liquids, fermented liquids, juice, wine and beer, distillates, petroleum products, medicaments, brines, fortified spirits, alcohols, gasses, and any mixture thereof.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

It is a further object of the invention to provide a method of monitoring fluid quality within a fluid flow in real time. The aforesaid method comprises the steps of: (a) providing a system said system comprising: (i) a fluid filter lined/incorporated into the fluid flow; the filter is adapted for filtering the fluid flow; (ii) sensor means adapted for measuring a difference between an upstream pressure and a downstream pressure of said fluid flow; and (iii) control means; (b) incorporating the system into the fluid flow; and (c) monitoring fluid quality.

It is a core purpose of the invention to provide the step of monitoring fluid quality performed by means of measuring a time period of rise in the pressure difference at said filter over a predetermined value.

It is a further object of the invention to provide the method further comprising a step of backflashing said filter by means of reversing the flow across the filter. The step of backflashing the filter is performed in response to rise in the pressure difference at the filter over a predetermined value.

It is a further object of the invention to provide the method further comprising a step of automatically replacing the filter. The control means activates the replacing means in a response to detecting a rise in said pressure difference above a predetermined value such that said filter is replaced when said upstream and downstream valves are closed.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a clogging rate monitor.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment or invention. Furthermore, the particular features, structures, or characteristics may be combined in any suitable manner in one or more embodiments. Lastly, the terms “comprising”, “including”, “having”, and the like, as used in the present application, are intended to be synonymous.

The term ‘plurality’ refers hereinafter to any integer number equal or higher than 1

The term ‘fluid’ and/or ‘water’ refers interchangeably hereinafter to a fluid selected from a group consisting, in a non-limiting manner, any flowing matter, especially fine particles, powders, nano- and micrometric-scale aggregates, milled fibers, corpuscles and other blood products, liquids, water immiscible solutions, water miscible solutions, water, water suspensions, emulsions, milk and milk products, blood, body fluids, beverages, brewed liquids, fermented liquids, juice, wine and beer, distillates, petroleum products, medicaments, brines, fortified spirits, alcohols, gasses, and any mixture thereof.

The invention comprises a method of directly measuring clogging rate. As a filter becomes more clogged with particles, the pressure difference across it will increase. The invention consists of measuring the pressure difference across a cleaned standard filter, and timing the interval required until it has clogged enough to cause a given threshold pressure to develop across it. When this pressure difference has reached a given threshold (e.g. 5 mm Hg pressure difference from upstream side of the filter to downstream side of the filter) a given amount of clogging has occurred in the filter. The amount of time required for this amount of clogging to occur is indicative of the ‘clogginess’ of the water, and directly relates to the clogging rate of any other element in the system that may clog such as taps, filters, nozzles, etc.

The filter is returned to its original unclogged state by running water through the filter in the reverse direction. Once the threshold pressure difference has been reached, it is cleaned by means of this reversed flow. This is achieved by use of electronically activated valves, such that human intervention is not required at any stage.

In the preferred embodiment of the invention, clogging rate information is displayed locally, and is also sent from the system in the form of an SMS message to a cell phone. This information consists of the time interval between the last filter-cleaning to the time at which the threshold pressure difference has been reached.

The apparatus is comprised of the following elements: a water filter, a differential pressure transducer with taps placed up- and down-stream of the filter, a control computer, a plurality of electronically activated valves, and a cellular phone modem.

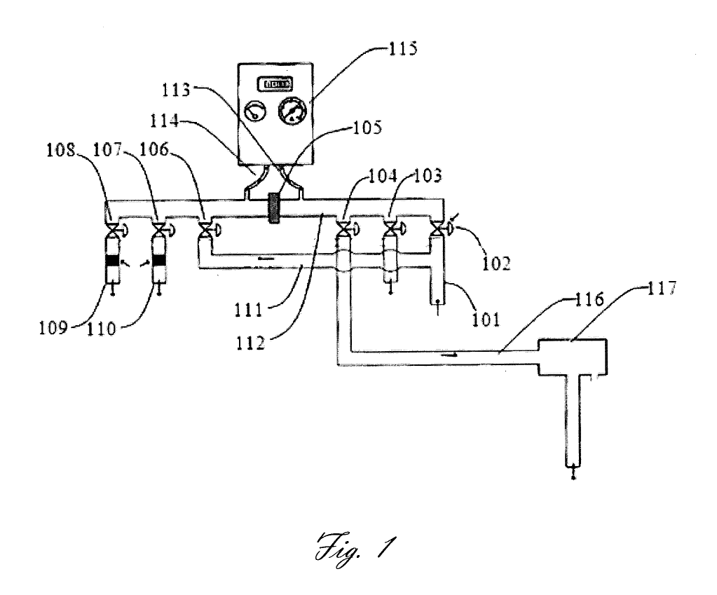

Reference is now made to FIG. 1. The water inlet 101 in normal operation supplies water at a nominal pressure. The valve 102 will normally be open, while valves 103 and 104 will normally be closed. This forces water through pipe 112 and past the filter 105. In normal operation valve 106 is closed while valves 107 and 108 are open, allowing water to exit through pipes 109 and 110. The heart of the device lies in the differential pressure monitor 115. Pressure transducers upstream 113 and downstream 114 of the filter 105 constantly monitor the pressure drop over the filter. By so doing the system senses the pressure drop over the filter. If this pressure drop is too great a series of corrective actions can be taken.

In one embodiment of the invention the water flow is reversed across the membrane for a brief period to unclog the filter. This is accomplished by closing valve 102, 107, 108 and opening valves 104, 106. It will be seen from the figure that this will result in reversing the flow through filter 105. This reversed flow will generally contain much sediment and is thus conducted through the bypass pipe 116, and through the sediment trap 117.

The method is comprised of the following steps:
1. A constant rate of flow is provided across a standard filter 105.
2. The pressure difference across the filter is monitored continuously by the control computer by means of the differential pressure transducer 115 and is compared to a threshold. Once the measured pressure difference is greater than the threshold, a series of steps is taken:
   a) An SMS message is sent to a cellular phone number previously entered in the control computer, the message consisting of the elapsed time since the threshold pressure was last reached until the current time.
   b) The valves 102, 107, 108 are closed.
   c) The valves 104 and 106 are opened. At this point the water flow through the membrane has been reversed. By means of this flow reversal the particles clogging the filter are removed into the water flow. Water will flow through bypass line 116 and past the trap 117.
   d) A preset amount of time is allowed to elapse.
   e) The valves 104 and 106 are closed.
   f) The valves 102, 107, 108 are opened. At this point the water flow through the filter is returned to its original direction.
   In a second embodiment of the invention, the filter 105 is simply replaced instead of being subjected to reversed flow.

The time taken for 5 mm Hg pressure gradient threshold to develop across a standard filter (time-to-clog) in the preferred embodiment exemplified in FIG. 1 is illustrated in Table 1 below:

| | Time to clog | | | |
|---|---|---|---|---|
| | <1 min | 1 min > 3 min | 3 min > 10 min. | >10 min. |
| Water type | Very dirty | Dirty | Moderately | Very |
| | | | Clean | Clean |

The standard flow rate used in the above example is a constant 500 liters of water per hour. This is the flow rate established for standard determinations of clogging rates in agricultural water supplies. For non standard or special cases where water quality evaluations must be made, lower or higher constant flow rates can be used and the time taken for about 5 mm Hg pressure gradient threshold to develop across a standard filter (time-to-clog) is established accordingly.

According to a preferred embodiment of the present invention, clogging rate is measured by measuring the time required until a given pressure difference as measured by a standard differential pressure transducer, develops over a standard filter under constant flow rate conditions.

According to a preferred embodiment of the invention, continuous operation is achieved by reversing the flow through the membrane once the threshold pressure is achieved.

According to a preferred embodiment of the invention, the clogging rate is transmitted over a wireless or cellular network to a remote party.

According to an alternative embodiment of the invention, the clogging rate is detected by measurement of the time rate of change of pressure difference across the membrane.

According to another embodiment of the invention, the method is used with a set of standard filters each of different mesh porosity and each with its own differential pressure transducer. In this way the clogging rates of different particle sizes can be determined.

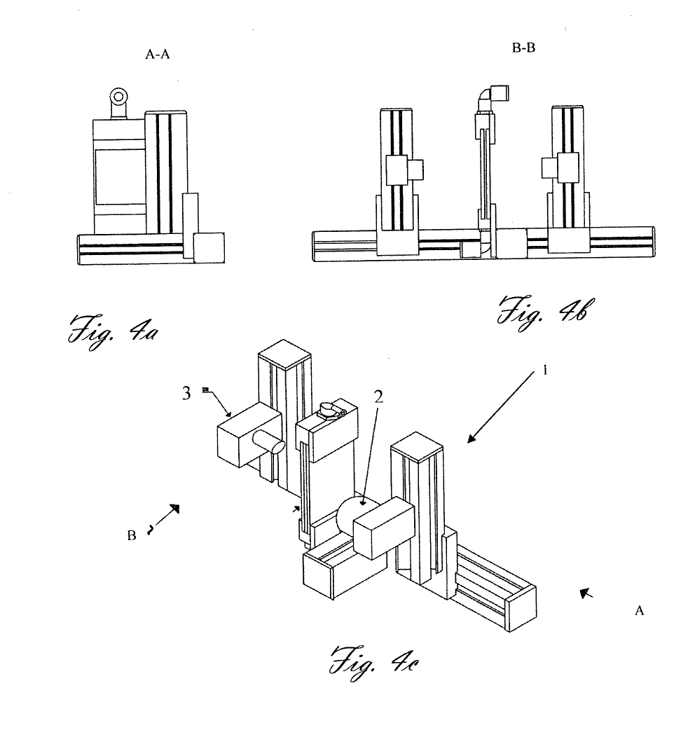

According to another alternative embodiment of the invention, the total suspended solids and/or suspended particle size distribution in the flow is determined in realtime by means of a video camera (see FIG. 4), connected to the control computer. In the top frames 4a, 4b side views are given along axes A,B. These axes are indicated in the isometric view of FIG. 4c. Here one sees the apparatus of the imaging system 1 including a light source 3 and sample cell 2.

In another embodiment of the invention, further provision is made for automated replacement of clogged filters. In one embodiment, when it is detected that a filter has been clogged, the filter in question is removed from the line. It will be clear to one skilled in the art that upstream and downstream valves will be preferentially closed automatically during this operation. A clean filter from a magazine provided is placed inline and the upstream and downstream valves reopened. The apparatus for this embodiment further provides a filter magazine, electronically controlled valves upstream and downstream of the filter, and means for automatic removal and replacement of the filter.

The method for this embodiment is comprised of the following steps:
1. A constant rate of flow is provided across a standard filter.
2. The pressure difference across the filter is monitored continuously by the control computer by means of the differential pressure transducer and is compared to a threshold. Once the measured pressure difference is greater than the threshold, a series of steps is taken:
   a) Valves upstream and downstream of the filter are closed.
   b) The clogged filter is removed.
   c) A new filter is placed inline
   d) The upstream and downstream valves are opened.

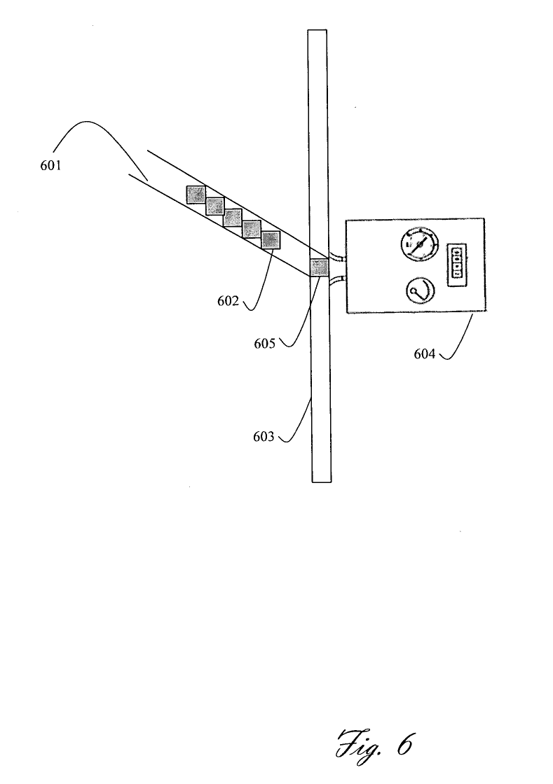

This embodiment is illustrated in FIG. 6. The magazine 601 contains a plurality of filters 602. When the inline filter 605 is clogged (as detected by the differential pressure transducer 604), the inline filter is removed and the next filter is placed into the fluid line 603.

In one example of this embodiment, the magazine holds around 20 filters of cylindrical form, about 10 cm in length and of a diameter slightly less than the fluid line. The fluid line is fitted with a section of pipe adapted for accepting these cylindrical filters.

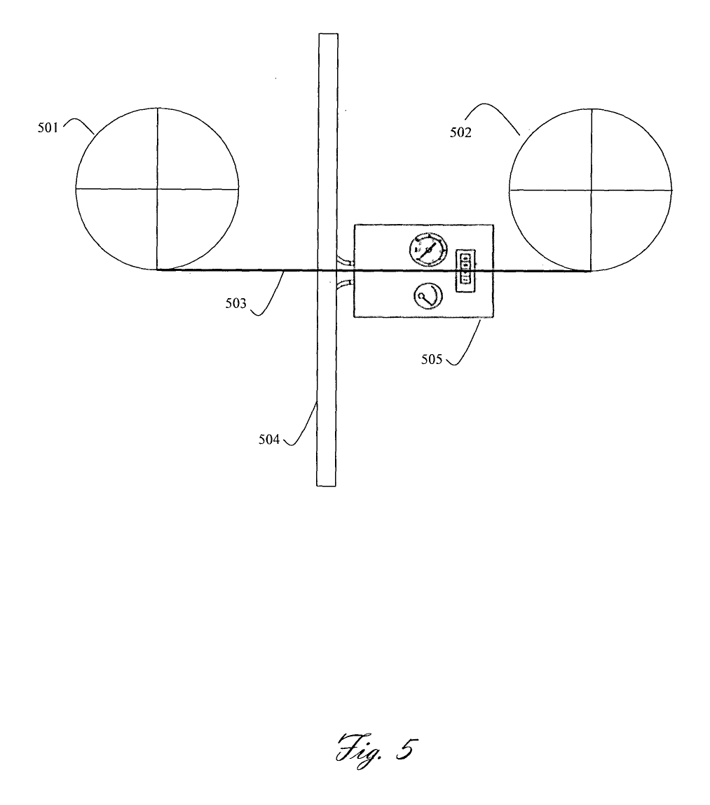

In another embodiment of the invention, instead of replacing filters, the filter itself comprises a segment of a long roll of filter material. When it is detected that the filter has become clogged or requires replacement, the roll is simply turned and a new segment of filter material is thereby introduced into the line. With reference to FIG. 5 this embodiment is illustrated in an exemplary manner. The differential pressure sensor 505 detects when the filter should be replaced. When this occurs, the release roll 501 and uptake roll 502 are caused to rotate about their axes, for example due to a motor mounted on the uptake roll. The filter band 503 is thereby shifted and a new segment is introduced into the fluid line 504. Since the release and uptake rolls can hold a considerable length of filter, the maintenance of the system is minimised. When the roll is entirely used, the used roll is removed and a fresh filter roll introduced onto the release spindle Replacement of the rolls at the end of this lifetime is simple.

One possible embodiment of this filter system comprises a filter strip of length e.g. about 10 meters and width appropriate to the pipe diameter, e.g. about 5 cm if the pipe diameter is about 6 cm. The fluid line is preferably fitted with a section of pipe adapted to accept this filter strip and allow it to be translated without leaking The uptake roll is preferably provided with an electronic mechanism to cause its rotation when the differential pressure sensor senses that the filter should be changed. The roll may be provided with sprockets for ease of advancement. When the differential pressure sensor senses that the filter should be replaced, the filter uptake reel is rotated, pulling a new section of filter strip into place within the fluid stream. This amount of rotation is preferentially made such that the filter strip is translated by about one pipe diameter. The filter strip may be replaced when it is entirely used.

1-56. (canceled)

57. A system for monitoring fluid quality within a fluid flow in real time, said system comprising:
a fluid filter incorporated into said fluid flow; said filter adapted for filtering said fluid flow;
sensor means adapted for measuring a difference between an upstream pressure and a downstream pressure of said fluid flow; and
control means;
wherein said control means is adapted for estimating said fluid quality by measuring a time period of rise in said pressure difference at said filter over a predetermined value.

58. The system according to claim 57, further comprises means for reversing the flow across said filter; said means are adapted for backflushing said filter in response to rise in said pressure difference at said filter over a predetermined value.

59. The system according to claim 57, further comprising normally open valves disposed in upstream and downstream positions relative to said filter and replacing means adapted for automatically replacing said filter; said control means is adapted for activating said replacing means in a response to detecting a rise in said pressure difference above a predetermined value such that said filter is replaced when said upstream and downstream valves are closed.

60. The system according to claim 57, wherein said sensor means is a differential pressure transducer.

61. The system according to claim 59, wherein said replacing means further comprising a feeding magazine adapted for feeding fresh filters to be placed as a substitute for a used one.

62. The system according to claim 59, wherein said filter is shaped into a strip wound on a reel, said replacing means is adapted for drawing said strip through said fluid flow.

63. The system according to claim 62, wherein said replacing means is adapted for drawing said filter through a flow area in a continuous and/or discrete manner.

64. The system according to claim 57, additionally provided with information transmission means through which said degree of pressure drop is transmitted.

65. The system according to claim 64, wherein said information transmission means is selected from a group consisting of: cellular radio network, cellular phone network, wireless transmission network, Ethernet connection, Bluetooth connection, serial connection, parallel connection.

66. The system according to claim 57, additionally providing means for real-time photography of water samples passing said filter.

67. The system according to claim 66, wherein said photography is of sufficient resolution and quality so as to enable sand, algae and zooplankton to be distinguished.

68. The system according to claim 57, wherein said fluid is selected from suspensions of solid matter, especially fine particles, powders, nano- and micrometric-scale aggregates, milled fibers, corpuscles and other blood products, liquids, water immiscible solutions, water miscible solutions, water, water suspensions, emulsions, milk and milk products, blood, body fluids, beverages, brewed liquids, fermented liquids, juice, wine and beer, distillates, petroleum products, medicaments, brines, fortified spirits, alcohols, gases, and any mixture thereof.

69. A method of monitoring fluid quality within a fluid flow in real time, said method comprising the steps of:
providing a system said system comprising:
a fluid filter incorporated into said fluid flow; said filter adapted for filtering said fluid flow;
sensor means adapted for measuring a difference between an upstream pressure and a downstream pressure of said fluid flow; and
control means;
incorporating said system into said fluid flow; and
monitoring fluid quality;
wherein said step of monitoring fluid quality is performed by means of measuring a time period of rise in said pressure difference at said filter over a predetermined value.

70. The method according to claim 69, further comprises a step of backflushing said filter by means of reversing the flow across said filter; said step of backflushing said filter is performed in response to rise in said pressure difference at said filter over a predetermined value.

71. The method according to claim 69, further comprises a step of automatically replacing said filter; said control means activates said replacing means in a response to detecting a rise in said pressure difference above a predetermined value such that said filter is replaced when said upstream and downstream valves are closed.

72. The method according to claim 69, comprising a step of providing a differential pressure transducer as said sensor means.

73. The method according to claim 71, comprising a step of providing said replacing means further comprising a feeding magazine adapted for feeding fresh filters to be placed as a substitute for a used one.

74. The method according to claim 71, comprising a step of providing said filter shaped into a strip wound on a reel and said replacing means adapted for drawing said strip through said fluid flow.

75. The method according to claim 72, comprising a step of providing said replacing means adapted for drawing said filter through a flow area in a continuous and/or discrete manner.

76. The system according to claim 69, additionally provided with information transmission means through which said clogging rate is transmitted.

77. The system according to claim 76, wherein said information transmission means is selected from a group consisting of: cellular radio network, cellular phone network, wireless transmission network, Ethernet connection, Bluetooth connection, serial connection, and parallel connection.

78. The system according to claim 69, additionally providing means for real-time photography of fluid samples passing said filter.

79. The system according to claim 78, wherein said photography is of sufficient resolution and quality so as to enable sand, algae and zooplankton to be distinguished.

80. The system according to claim 78, wherein said fluid is selected from suspensions of solid matter, especially fine particles, powders, nano- and micrometric-scale aggregates, milled fibers, corpuscles and other blood products, liquids, water immiscible solutions, water miscible solutions, water, water suspensions, emulsions, milk and milk products, blood, body fluids, beverages, brewed liquids, fermented liquids, juice, wine and beer, distillates, petroleum products, medicaments, brines, fortified spirits, alcohols, gasses, and any mixture thereof.
